(19) United States
(12) Patent Application Publication
(10) Pub. No.: US 2021/0140403 A1
(43) Pub. Date: May 13, 2021

(54) UNIT TO FACILITATE THE GENERATION OF ELECTRIC POWER FROM SOLAR AND WIND ENERGY

(71) Applicant: Energy Asset Development Inc, Des Plaines, IL (US)

(72) Inventor: Narinderpal S. Sood, Des Plaines, IL (US)

(73) Assignee: ENERGY ASSET DEVELOPMENT INC, Des Plaines, IL (US)

(21) Appl. No.: 16/920,546

(22) Filed: Jul. 3, 2020

Related U.S. Application Data
(60) Provisional application No. 62/932,366, filed on Nov. 7, 2019.

(51) Int. Cl. F03D 1/04; F03D 9/11; F03D 9/45

(52) U.S. Cl. CPC F03D 1/04; F03D 9/11; F03D 9/45; F05B 2260/42; F05B 2220/7062; F05B 2220/708; F05B 2260/20; F05B 2250/5011

(57) ABSTRACT

An apparatus to produce electricity from several renewable energy sources. The device collects wind into a duct, adds energy to the collected wind by adding heat from the sun and building exhaust, and produces electricity via a generator therefrom. The wind capture unit includes a plurality of faces that face all compass directions to avoid having to adjust the device upon shifts in wind direction and speed. The duct includes a tapered portion that serves to increase a speed of inflow air prior to impinging upon a turbofan generator. The device can be mounted on a top of a building and receive building exhaust while supplying the building with electricity. The result is a higher efficiency device with pleasing aesthetics.

### CROSS REFERENCE TO RELATED APPLICATIONS

This application claims an invention which was disclosed in Provisional Application No. 62/932,366, filed on Nov. 7, 2019 in the USPTO, entitled “Unit to Facilitate the Generation of Electric Power from Solar and Wind Energy”. The benefit under 35 USC § 119(e) of the United States provisional application is hereby claimed, and the aforementioned application is hereby incorporated herein by reference.

### FIELD OF THE INVENTION

The present invention relates generally to equipment for production, distribution, or transformation of energy. More specifically, the present invention is a unit to facilitate the generation of electric power from solar and wind energy.

### BACKGROUND OF THE INVENTION

Wind energy is used to generate electric power from wind using a wind turbine. Earlier wind turbines have a 3-blade wind turbine unit. Further, solar energy is also used to generate electric power from the sun using solar photovoltaic cells.

The earlier method of extraction of wind energy has certain limitations. To begin with, the conversion efficiency of 32% due to the Betz limit is low. The earlier wind turbine also has architectural problems, is aesthetically displeasing in an urban environment, and may violate local zoning restrictions. Also, the earlier large wind turbine generator diameter is difficult to handle and repair. The earlier wind turbine also blemishes the aesthetic beauty of the countryside and poses a safety hazard in the event of inclement weather involving gale force winds, threatening great damage to life and property. The earlier wind turbine also has a lower efficiency of energy conversion of about 32%, in accordance with the Betz limit, and requires a large force to be imposed on the wind turbine structure in order to change the turbine rotor direction upon a shift in wind direction.

The earlier method of extraction of solar energy using solar photovoltaic cells also has certain limitations. Solar photovoltaic cells are expensive, the solar photovoltaic panel has to be kept clean of dust particles in order to deliver highest efficiency, and the earlier solar photovoltaic cell panel has an efficiency of conversion of solar energy to electricity of well below 20%. Therefore, what is needed is an improved unit to facilitate the generation of electric power from solar and wind energy that may overcome one or more of the above-mentioned problems and/or limitations.

### SUMMARY OF THE INVENTION

It is therefore an object to provide a more efficient method and apparatus of harnessing clean, renewable wind and solar energy that could reach efficiencies of 90% by also harnessing solar heat and by tapering a duct that receives wind energy and thereby increasing wind speed.

It is further an object of the present invention to provide an apparatus and method of harnessing clean and renewable wind suitable for a high building in an urban environment where zoning and aesthetics are an issue and where traditional wind turbine designs are inappropriate, to thus expand a range of locations harnessing wind energy can be exploited.

It is also an object of the present invention to provide a technique and device to harness wind energy that is significantly less expensive than existing methods.

It is also an object to provide an apparatus to harness renewable wind energy that does not require adjustments of the structure upon shifts in wind direction and speed.

It is further an object of the present invention to provide an apparatus and method of harnessing clean and renewable wind and solar energy that can simultaneously harness both wind and solar energy using a single apparatus.

It is further an object of the present invention to provide an apparatus and method of harnessing clean and renewable wind and solar energy that can also harness the energy of building exhaust air.

These and other objects can be achieved by providing a renewable power production arrangement arranged on a rooftop of a building to produce power for the building, the renewable power production arrangement including a wind capture unit to receive and collect ambient wind from an atmosphere, a duct having a first end opposite a second end, the first end being connected to the wind capture unit to receive the collected ambient wind from the wind capture unit and to pass the collected wind therein as an influx air flow, a generator connected to the second end of the duct shaped as a diffuser to convert the influx air flow into electricity, an enthalpy boosting unit to introduce heat and/or air mass flow into the influx air flow within the duct at a location between the first and second ends, the introduced heat energy being received from a source selected from a solar collector, ventilation exhaust from the building and air conditioning exhaust from the building.

The wind capture unit may be adapted to receive wind from all compass directions without by including a plurality of faces to collect air from differing compass directions. The wind capture unit may be adapted to automatically receive wind from all directions without adjustment, wherein the duct comprises a tapered portion between the first and second ends to increase a speed of the influx air flow by reducing a cross-sectional area of the duct prior to introduction of the influx air flow into the expansion turbine located in the diffuser section.

According to another aspect of the present invention, there is provided a renewable power production arrangement including a duct to allow an influx air flow to travel therein, a wind capture unit connected to the duct and including a plurality of faces to receive ambient wind from an atmosphere and produce the influx air flow and a generator to convert the influx air flow into electricity, the wind capture unit being adapted to receive wind from all directions without being adjusted, the arrangement being mounted on a roof of a building.

The plurality of faces may include at least four faces corresponding to North, South, East and West compass directions to receive said ambient wind from any and all compass directions without a need to adjust the wind capture unit. The duct may include a tapered portion to increase a speed of the influx air within by reducing a cross-sectional area thereof.

The arrangement may further include an enthalpy boosting unit to introduce energy into the influx air flow within the duct. The enthalpy boosting unit may include a solar heat exchange unit to harness energy from the sun and transfer said harnessed energy to the influx air flow. The enthalpy boosting unit may also include an exhaust air introduction unit to introducing received heated exhaust air from the building into the influx air flow. The heated exhaust air may be from one or both of ventilation exhaust air and air conditioning exhaust air.

The solar heat exchange unit may include a solar collector to absorb sunlight and produce heat energy from the absorbed sunlight, a heat transfer fluid to receive the heat energy from the solar collector and a heat exchanger to transfer the heat energy from the heat transfer fluid to the influx air flow within the duct. The solar heat exchange unit may also include a pump to circulate the heat transfer fluid between the solar collector and the heat exchanger, the solar collector being exposed to direct sunlight. The generator may be a DC generator and include an expansion turbine to receive the influx air flow from the duct and convert the influx air flow into rotational energy and a generating portion to convert the rotational energy received from the expansion turbine into DC electricity.

The arrangement may also include an energy storage unit connected to the DC generator to receive and store DC electricity produced by the DC generator, the energy storage unit being a system of batteries. The arrangement may also include an inverter connected from the energy storage unit to convert the DC electricity received from the energy storage unit into AC electricity. The produced AC electricity may be used to power appliances within the building. The generator being a DC generator that may include a turbofan or expansion turbine to receive the heated influx air flow from the duct and convert the heated influx air flow into rotational energy and a generating portion to convert the rotational energy received from the turbofan into DC electricity, the DC electricity being converted into AC electricity by an inverter prior to powering appliances within the building.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram of an apparatus that produces electricity from renewable energy sources according to the principles of the present invention;

FIG. 2 is a block diagram of the duct-generator unit according to the principles of the present invention;

FIG. 3 is an isometric view of a wind capture unit according to the principles of the present invention;

FIGS. 4a and 4b is a top view and a front view respectively of a duct according to the principles of the present invention;

FIG. 5 is a view of a duct according to an embodiment of the present invention;

FIG. 6 is a schematic diagram of a solar heating unit according to the principles of the present invention;

FIG. 7 is a block diagram of a commercial building ducting exhaust air into the duct according to the principles of the present invention;

FIG. 8 is a cross-sectional view of an end of the duct being connected to a turbofan-generator unit according to the principles of the present invention;

FIG. 9 is a block diagram of the apparatus of that produces electricity from renewable sources deployed on a building according to one embodiment of the present invention; and

FIG. 10 is a block diagram of the apparatus of that produces electricity from renewable sources deployed on a building according to another embodiment of the present invention.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of the best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the generation of electric power from solar and wind energy, embodiments of the present disclosure are not limited to use only in this context.

Overview:

The present disclosure describes an improved unit for the generation of electric power from solar and wind energy. The unit may generate electrical power based on one or more scientific principles such as the principle of continuity, the principle of conservation of energy, etc. According to the principle of continuity: what flows into a defined volume in a defined time, minus what flows out of that defined volume in that time, must accumulate in that defined volume. The principle of continuity is a consequence of the law of conservation of mass, and conservation of energy is defined as energy is neither created nor destroyed, but only converted from one form to another. The unit uses a wind capture unit to collect an influx air 200 from a plurality of directions. The influx air 200 is guided into a tapering duct, which helps in increasing the velocity of the influx air 200 in the tapering duct according to the principle of continuity. The tapering duct includes turbine-generator apparatus which is configured to generate DC power from the flow of the influx air 200 according to the principle of conversation of energy.

An alternative explanation for the present invention is the first law of thermodynamics and the conservation of energy. For a closed system, the first law of thermodynamics states:

ΔU=Q+W Equation 1

where ΔU is a change of internal energy U of a closed system, Q is heat energy of the system and W is work done on the system. In a closed system, energy can not be created or destroyed, it can only be converted from one form to another. If the system is heated, then the internal energy of the system is increased, and if the system does work such as make a turbine spin or generate electricity, then the internal energy U of the system decreases. The inventor has recognized that if heat is added to a wind capture system, then the amount of work that it can then perform can also increase.

In an open system, the first law of thermodynamics states:

ΔU=Q+W+ΔU_{massflow} Equation 2

where ΔU_{massflow} is the mass flow added to the system. The added mass flow ΔU_{massflow} is could be expressed as the added kinetic energy of the newly introduced mass flow, expressed as mv²/2, where m is the mass of the newly added material and v is the velocity of the newly added material. The inventor has also recognized that exhaust air from a building's air conditioning system and ventilation exhaust can be added to the wind capture system to increase the total energy U of the system to produce more energy. Also, the inventor has realized that the exhaust from a building may be heated, and therefore boost the enthalpy of the system by adding heat Q to the system. Consequently, Applicant has realized that by incorporating a solar heater as well as building exhaust into the wind collection, more electricity can be generated.

While a high-rise building is an example case, application to residential single user situations, as well as to commercial applications with multiple users such as an industrial park applications with multiple users, or to residential multi-user applications is intended. This disclosure contemplates forming the basis for a micro grid, in which case, it will require a DC distribution system to accommodate multiple users. Even when applied to a high-rise building, there are situations where DC power would be fed to more than one user. Therefore, while not a requirement, a DC network, local in nature, may be connected to the ESS. In addition, the power production arrangement could be in a remote location which would refer to any off-site location with respect to the building

Further, ventilation exhaust air (from a building) may be guided into the tapering duct to supply additional mass flow in the influx air 200. According to the principle of continuity, the additional mass flow may increase air velocity in the tapering duct. The increase in the air velocity increases the kinetic energy and therefore the internal energy of influx air 200 in the tapering duct, which may result in generating more power using the turbine-generator apparatus.

The unit is configured to facilitate the heating of the influx air 200 in the tapering duct using heat recovered from solar collector. Moreover, exhaust heat (from a building) may be used for heating the influx air 200 in the tapering duct. The heating of the influx air 200 may increase the internal energy velocity v of the influx air 200 within the duct. The increase in velocity v increases the kinetic energy mv²/2, which increases the internal energy U of the influx air 200 may e the velocity of the influx air 200 which may help in generating more power using the turbine-generator apparatus.

The unit may include a wind capture unit. The wind capture unit may be configured to facilitate the collection of an influx air 200 from a plurality of directions. The plurality of directions may include east-west-north-south directions. The unit may include a tapering ductwork to increase the velocity of the influx air 200. The unit may be configured to facilitate the heating of the influx air 200 in the tapering ductwork using a solar collector. The solar collector may facilitate an increase in energy content in the flow of the influx air 200. The solar collector may include a heat transfer fluid. The heat transfer fluid may transfer the heat energy to the influx air 200 in the ductwork using a heat exchanger. The HVAC exhaust air may facilitate the addition of mass flow rate and the energy content to the influx air 200. The exhaust air may facilitate the heating of the influx air 200 in the tapering ductwork. The unit may include a turbine-generator apparatus. The turbine-generator apparatus may include a turbofan. The turbofan may be associated with a multi-staged turbofan. The turbine-generator apparatus may generate DC power from the flow of the influx air 200. The DC power may be stored in an energy storage unit. The energy storage unit may include a DC battery. The unit may include an inverter. The inverter may facilitate the conversion of the DC power to an appropriate user-determined voltage and a mono or three-phase electricity. The unit may include monitoring devices and unit of sensors.

According to some embodiments, an improved unit for the generation of electric power from solar and wind energy is disclosed. The unit may be installed in industrial, institutional, commercial and residential buildings. The unit may be designed with the site characteristic in mind. The unit may include a wind capture unit to facilitate the collection of influx air 200. The wind capture unit may have openings (faces) in four directions. The faces may be covered with a screen to prevent damage to birdlife. The influx air 200 may contain energy. The influx air 200 may be associated with an energy density. The energy density may correspond to the energy contained in the influx air 200. The influx air 200 may be heated using a solar heater and HVAC exhaust air. The solar heater may provide thermal energy to the influx air 200, thereby improving the energy density of the influx air 200. The exhaust air may include ventilation exhaust air and AC exhaust air. The ventilation exhaust air may be ducted in the duct to supply additional mass flow in the influx air 200. The ventilation exhaust air may be ducted in the duct to add heat energy in the influx air 200, thus increasing the electrical output from a turbofan-generator unit. The AC exhaust air may facilitate the enhancement of electrical energy production. The influx air 200 may be fed into a DC generator to produce DC power. The DC power may be stored in an energy storage unit. The DC power stored in the energy storage unit may be converted into AC power using an inverter. The AC power from the inverter may be fed to a building power unit.

Turning now to the figures, FIG. 1 is a block diagram of a renewable power production arrangement 100 to facilitate the generation of electric power from solar and wind energy in accordance with an embodiment of the present invention. Arrangement 100 includes duct 20, wind capture unit 10 attached to duct 20 to collect and receive wind impinging thereon and produce an influx air flow 200 within a duct 20, an enthalpy boosting unit 350 to add internal energy to the influx air 200, a duct 20 to guide the airflow and including a tapered portion to increase flow speed of the influx air 200, a generator 50 to produce electricity from the influx air 200, and an electrical portion 360 to store the produced electricity and to transform the produced electricity to a form suitable for powering a home or for redistribution onto an electrical power grid.

Referring now to FIGS. 1 and 3, the wind capture unit 10 may be associated with at least one wind parameter selected from wind speed, wind direction, etc, which could be determined by at least one wind sensor. As illustrated in FIG. 3, the wind capture unit 10 may have a plurality of openings (faces) 14 in all four directions. Opening 14E may face east and collect easterly winds, 14W may face west and collect westerly winds, opening 14N may face north and collect northerly winds, and opening 14S may face south and collect southerly winds, but the present invention is in no say so limited. The openings 14 may be configured to receive ambient wind to produce an influx air flow 200 within duct 20. The influx air flow 200 may be guided into duct 20 by the openings 14 in the wind capture unit 10. The duct 20 may include a tapered portion having a tapered cross-sectional area to increase the velocity of the influx air 200 proportional to the reduction in cross-sectional area of the duct 20. For example, the velocity of the influx air 200 of 10 mph may be increased to 300 mph through a reduction in cross-sectional area by a factor of 30:1 in tapered portion 22 of duct 20. Alternately, the tapered portion may reduce the cross sectional area by a factor of 100 to increase a 6 mph incident wind to a speed of 600 mph. In an alternate variation, the mass flow of influx air flow 200 received from collector may be 200 lbs/minute. One or both of AC exhaust 44 and building ventilation exhaust 42 may add a mass flow of 10 lbs/min to reach a total mass flow of 210 lb/min. Tapered portion 22 of duct may reduce the cross sectional area by a factor of 50, thereby increasing the mass flow to 1050 lbs/min prior to impinging onto to generator 50. In yet another variation, the tapering portion may be eliminated altogether if it is deemed that the input wind speed falls within the range of the turbofan 54 of generator unit 50. If such a serpentine duct causes increased friction, said friction would heat influx air flow 200 and still remain as internal energy, and the loss of velocity due to friction could be compensated for in designing the tapering portion.

The arrangement 100 of FIG. 1 may further include an enthalpy boosting unit 350 that adds internal energy in the form of heat and/or mass flow to the incident influx air 200. This enthalpy boosting unit 350 may include one or more of a solar heat exchange unit 30 and exhaust air introduction unit 40. The arrangement 100 of FIG. 1 pertains to an embodiment where enthalpy boosting unit 350 includes both a solar heat exchange unit 30 and an exhaust air introduction unit 40, however the present invention is in no way so limited as the enthalpy boosting unit 350 can instead include one or the other of a solar heat exchange unit 30 and an exhaust air introduction unit 40, or enthalpy boosting unit 350 can instead include only the exhaust air introduction unit 40, or the enthalpy boosting unit 350 can be entirely omitted and still be within the scope of the present invention.

As illustrated in FIG. 6, the solar heat exchange unit 30 may facilitate heating of the influx air 200 within duct 20 and increase the total energy U of the influx air 200 by increasing the heat content Q of internal air flow 200. The solar heat exchange unit 30 may include a solar collector 32, a heat transferring fluid 34, a pump 36 to circulate the heat transferring fluid 34, and a heat exchanger 38 to transfer heat from the fluid 34 to the influx air 200 traveling through duct 20. The solar collector 32 may absorb sunlight and may include a flat plate solar collector, an evacuated tube collector, a parabolic collector, etc. The solar energy may be associated with a solar parameter, including one or more of solar radiation intensity reading, solar power reading, etc. The solar parameter may be determined by at least one solar sensor. The solar energy may be transferred from the solar collector 32 to the heat transfer fluid 34. The heat transfer fluid 34 may be associated with heat energy. For example, the heat transfer fluid 34 may include one or more of water, heat transfer oil, glycol, refrigerant, etc. The heat transfer fluid 34 may exchange heat energy with the influx air 200 in the duct 20 by way of heat exchanger 38.

In the arrangement 100 of FIG. 1, enthalpy boosting unit 350 may also include air exhaust unit 40 that receives a warm or a hot exhaust air stream from a building that is associated with an industrial, an institutional, a commercial building or a residential building and introduce said warm or hot exhaust air stream into duct 20 to heat influx air 200. As a result, enthalpy ΔU_{massflow} of influx air flow 200 as well as the heat content Q, thereby increasing the total internal energy U of influx air flow 200, increasing the amount of work or electricity W that can be ultimately produced.

The exhaust air in exhaust unit 40 may come from one or both of a ventilation exhaust air 42 and HVAC or air conditioning exhaust air 44. The ventilation exhaust air 42 may be associated with internal ventilation of a building. The HVAC exhaust air 44 may be associated with the internal conditioning of air within the building. The exhaust air may be introduced into duct 20 in order to heat the influx air 200.

The arrangement 100 may also include generator unit 50 to generate electricity from the influx air 200. Generator unit 50 may be a turbofan-generator unit. The influx air 200 may be fed into the turbofan-generator unit 50. The turbofan-generator unit 50 may include a turbofan 54 that rotates upon being immersed within an airstream such as influx air flow 200 and a DC generator 52 that generates DC power from the rotation of turbofan 54. The DC power may be associated with a DC power reading that may be read from a DC meter. The DC generator 52 may be selected from a permanent magnet DC generator, a separately excited DC generator, a self-excited DC generator, etc. The DC generator 52 can be coupled to a turbofan 54. The turbofan 54 may be an axial flow turbofan.

The arrangement 100 of FIG. 1 may further include an electrical portion 360 to store and transform electricity produced by generator 50. Electrical portion 360 includes an Energy Storage System (ESS) 60 to store DC power generated by generating unit 50. For example, the energy storage system 60 may be selected from a battery, an accumulator, etc. Any battery unit suitable for the ESS 60 may be used. Electrical portion 360 further includes charge controller 80 that may be interposed between generator unit 50 and the ESS 60. Electrical portion 360 further includes inverter 70 to convert direct current (DC) electricity produced by generator 50 into alternating current electricity, and transform it to have a voltage, phase, frequency and/or waveform so that it is compatible with electrical appliances within a building or an electrical grid. The inverter 70 may be selected from a sine wave inverter, a square wave inverter, etc. Furthermore, electrical portion 360 may also include an alternating current meter 90 to measure the amount of electricity produced or delivered.

The arrangement 100 may include transferring the alternating current (AC) power to a building power unit. The AC power may have a voltage and a phase required by facility power unit, and may run an electrical appliance of the rated voltage. Alternatively, the AC power could be sold to an electrical power grid.

Turning now to FIG. 2, FIG. 2 is a block diagram of the duct-generator unit in accordance with some embodiments. In FIG. 2, duct 20 connected to turbofan-generator 50 is illustrated. Duct 20 may carry the influx air 200. The influx air 200 may be fed into the turbofan-generator 50 to generate electric power that may be stored in battery 60. As illustrated in FIG. 2, turbofan generator 50 may include a plurality of generator units 50a, 50b and 50c. By using a plurality of generator units 50a, 50b and 50c instead of just one generator unit, a scenario of including a very large generator can be avoided as it may be impractical for an extremely large generator to be used. For example, if the arrangement 100 were to be designed for a roof of a hospital that uses 3MW during peak usage, an arrangement 100 could be designed to produce 2.5 MW, allowing for storage of produced electricity during off peak times. In such a scenario, three generating units, each of a capacity of 800 kw to 1 MW could be used in generating unit 50.

Turning now to FIG. 3, FIG. 3 is an isometric view of wind capture unit 10 in accordance with some embodiments. Wind capture unit 10 may have four faces 14E, 14W, 14N, 14S in East-West-North-South direction to collect wind flow from all directions or points of compass and avoid the need for making an adjustment of the wind collector 10 or any other component in arrangement 100 upon a shift in wind direction and speed. The faces 14 may be covered with a screen or a cross-hatch to prevent infiltration and damage due to birds and other wildlife. The faces 14 may be connected to common duct 20.

In some embodiments, wind capture unit 10 may not be a single integral monolithic unit, which would allow for assembly and easy installation on tall building rooftops, especially in cramped environments when there is other equipment on the rooftop. Accordingly, four faces 14E, 14W, 14N and 14S may effectively capture all wind at an angle, effectively receiving wind from two of the four faces for any given incident wind direction. At most, only two of the four faces 14 of the wind capture unit 10 will be exposed to wind direction of influx air 200 at any point in time, except when oriented directly perpendicular to the applicable face, in general, allowing the device to be able to effectively catch wind from any direction.

Turning now to FIGS. 4A and 4B, FIGS. 4A and 4B are orthographic projection including top and side views respectively of wind capture unit 10. The wind capture unit 10 may be attached to first end 23 of duct 20. As illustrated in FIGS. 4a and 4b, baffles 12 may be arranged within collector 10 and correspond to boundaries between each two adjoining faces 14. Baffles 12 prevent cross flow of influx air 200 between two adjoining faces. FIG. 4a shows 4 baffles 12, but in no way is the present invention so limited. FIG. 4b illustrates baffles 12 extending into first end 23 of duct 20, but in no way is the present invention so limited.

The duct 20 may include internal baffles 22 to prevent cross-flow of the influx air 200. The internal baffles 22 may be adjustable allowing control over influx air flow 200. The duct 20 may also be provided with external insulation 26 (see FIG. 7). The external insulation 26 may include fiberglass material, Reflectix® material, etc. The external insulation 26 may resist condensation and leakage of the influx air 200 within duct 20 as well as leakage of heat to the outside.

Turning now to FIG. 5, FIG. 5 illustrates a duct 20 according to one embodiment of the present invention. The duct 20 may made from galvanized sheet metal which may have a zinc coating to prevent rusting. Duct 20 includes a first end 23 connected to wind capture unit 10 and a second and opposite end 25 connected to diffuser section at the other end unit 50. Duct 20 further includes a tapered portion 22 arranged between first end 23 and second end 25. For example, the influx air 200 at 10 mph may be increased to 300 mph through a 30:1 cross-sectional area reduction ratio. As illustrated in FIG. 5, influx air flow 200 travels from first end 23 to second end 25. Tapered portion 22 serves to increase a velocity of the influx air flow 200 prior to impinging on turbofan 54 of generator unit 50. Duct 20 further includes insulation 26 in order to preserve internal energy of the influx air flow 200 therein. With insulation 26, any frictional energy generated between influx air flow 200 and duct 20 can be converted into heat Q that can heat influx air flow 200, thereby improving efficiency and reducing any loss of internal energy U of influx air flow 200. Although not illustrated, duct 20 may also include ports to receive mass air flow from exhaust unit 40. Such ports can be connected to any portion of duct 20 between first end 23 and second end 25 that is convenient from an engineering standpoint, provided that they are behind (i.e. upstream) from the generator 50. Also a heat exchanger 38 (not illustrated) may be connected to any portion of duct 20 between first end 23 and second end 25 that is convenient from an engineering standpoint to heat influx air flow.

Although FIG. 5 illustrates duct 20 as being vertically oriented, in no way is the present invention so limited as duct 20 can instead be arranged horizontally, be straight or have a curved or even a serpentine configuration, or any other design or orientation. In fact, duct 20 can take on any routing shape and still be within the scope of the present invention. It is also to be appreciated that each installation of the renewable power production arrangement of the present invention is unique and can be designed according from an architectural and engineering standpoint. For example, it is possible for the wind collector 10 to be on a roof of a high rise building and the turbine be on the ground and have duct wrap around the high rise building on the exterior thereof between the roof and the ground and still be within the scope of the present invention. Or duct may be horizontally disposed on a roof between the turbine and the wind collector, and still be within the scope of the present invention.

Turning now to FIG. 6, FIG. 6 is a schematic diagram of the solar heat exchange unit 30 in accordance with some embodiments. The solar heat exchange unit 30 may include a solar collector 32, a heat transfer fluid 34, a fluid flow transfer mechanism 36 and a heat exchanger 38. The solar collector 32 may absorb sunlight. For example, the solar collector 32 may include a flat plate solar collector, an evacuated tube collector, a parabolic collector, etc. The solar energy absorbed by collector 32 may be transferred to heat transfer fluid 34. The heat transfer fluid 34 may be associated with heat energy. For example, the heat transfer fluid 34 may include at least one of water, glycol, refrigerant, etc. The fluid flow transfer mechanism (i.e. pump) 36 may circulate the fluid and provide flow energy to the heat transfer fluid 34. The heat transfer fluid 34 may transfer heat energy from solar collector 32 to heat exchanger 38. Heat exchanger 38 may transfer the heat energy from fluid 34 to influx air flow 200 within the duct 20, thereby boosting the heat Q of influx air flow which causes the total internal energy U of influx air flow 200 to rise. As more heat is added to influx air flow 200 within duct 20, the energy content of influx air flow 200 is boosted, thereby boosting the amount of electricity that can be produced.

Turning now to FIG. 7, FIG. 7 is a block diagram of the exhaust air introduction unit 40 of the renewable power production arrangement 100 in accordance with some embodiments. The exhaust air introduction unit 40 can serve to introduce one or both of ventilation exhaust air 42 and air conditioning exhaust air 44 expelled from building 300 into influx air 200 within duct 20 of renewable power production arrangement 100. This serves to increase the energy flow rate ΔU_{massflow} and therefore the total internal energy U of influx air flow 200, thereby boosting the amount of electricity that can be generated.

Turning now to FIG. 8, FIG. 8 is a cross-sectional view of second end 25 of duct 20 being connected to turbofan-generator unit 50 in accordance with some embodiments. The unit 50 includes a turbofan 54 and a DC generator 52. Turbofan 54 receives heated influx air flow 200 from duct 20, resulting in turbofan 54 being rotated, which causes DC electricity to be produced by DC generator 52. The DC electricity produced by DC generator 52 may then be delivered to and stored within energy storage system 60.

It is to be appreciated that a user can select a generator unit from many possible generator units and select a duct 20 with a tapering portion 22 from many designs based on typical wind conditions for a locale that the renewable energy generation arrangement 100 is to be installed. If a wind speed range in a particular locale is light, then the generator and duct need to be selected so that the typical wind speeds for a particular region, when amplified by tapered portion 22, would result in a velocity within a range for a particular generator chosen. It is further to be appreciated that the arrangement 100 may further include a safety shut off switch to shut the arrangement 100 off if the incident wind speed is too great for arrangement 100 to safely operate or when amplified by tapered portion 22, would fall outside a range of the selected generator unit 50.

Turning now to FIG. 9, FIG. 9 is a block diagram 500 illustrating an implementation of the renewable power generating arrangement 100 of FIG. 1 according to an embodiment of the present invention. As illustrated in FIG. 9, renewable power generating arrangement 100 of FIG. 1 is installed on a roof 340 of building 300. In the arrangement of FIG, 8, the renewable power generating arrangement 100 includes an enthalpy boosting unit 350 that includes each of a solar heat exchange unit 30 and an air exhaust unit 40 that includes both ventilation exhaust air 42 and HVAC exhaust air 44. Power produced from renewable power generating arrangement 100 may be used to power building 300, and the exhaust air from ventilation 42 and HVAC 44 of building 300 is fed into duct 20 of renewable power generating arrangement 100 to boost the energy content of influx air flow 200 by adding heat to influx air flow to facilitate an increase in an amount of electricity that can be eventually generated.

Accordingly, the renewable power generating unit 100 illustrated in FIG. 9 may include a wind capture unit 10. The wind capture unit 10 may facilitate the collection of influx air 200. Further, as shown in FIG. 3, the wind capture unit 10 may have openings/faces 14 in all four directions to enable capture of wind regardless of the wind direction, overcoming the need to adjust or rotate the apparatus upon a shift in wind direction. The influx air 200 may be guided into duct 20 by wind capture unit 10. The duct 20 may have a tapered portion 22 to increase influx air velocity proportional to the reduction in cross-sectional area. For example, the velocity of the incident influx air 200 of 10 mph may be increased to 300 mph through a reduction in cross-sectional area by a factor of 30:1.

The renewable power generating unit 100 of the block diagram 500 of FIG. 9 may also include an enthalpy boosting unit 350 to introduce energy in the form of heat and/or mass flow into the influx air 200. In the arrangement of FIG. 9, the influx air 200 may be treated by both a solar heater 30 and exhaust air heater 40. The solar heater 30 may facilitate heating of the influx air 200 in the duct 20. The solar heater 30 may include a solar collector 32. For example, the solar collector 32 may include a flat plate solar collector, an evacuated tube collector, a parabolic collector, etc. The solar collector 32 may absorb sunlight. The absorbed solar energy may be transferred to the heat transfer fluid 34. The heat transfer fluid 34 may be associated with heat energy. For example, the heat transfer fluid 34 may include one or more of water, glycol, refrigerant, etc. The heat transfer fluid 34 circulates to transport the heat energy received from solar collector 32 to heat exchanger 38 so that the heat energy can be then delivered to influx air flow 200 within duct 20, thereby boosting the energy content of influx air flow 200. The exhaust air heater 40 may be associated with an industrial, an institutional, a commercial building or a residential building. The exhaust air heater 40 may include ventilation exhaust air 42 and HVAC exhaust air 44 from building 300. The ventilation exhaust air 42 may be associated with internal ventilation of building 300. The HVAC exhaust air 44 may be associated with the internal conditioning of air within building 300. The exhaust air 42 and 44 may be ducted into duct 20 in order to boost a mass flow and thus internal energy content of influx air flow 200 by raising the temperature, mass flow rate total internal energy of influx air flow 200 to enable more electricity to eventually be produced.

The renewable power generating unit 100 of the block diagram 500 of FIG. 9 may generate DC power from the influx air 200 using a turbofan-generator unit 50. The influx air 200 may be fed into the turbine-generator unit 50. The generator may include a turbofan 54 and a DC generator 52. For example, the DC generator 52 may include at least one of a permanent magnet DC generator, separately excited DC generator, self-excited DC generator, etc. When turbofan 54 is immersed within influx air flow 200, turbofan 54 rotates, thereby driving DC generator 52 so that electricity can be produced.

Electricity from generator unit 50 of arrangement 100 of the block diagram 500 of FIG. 9 enters electrical portion 360 for storage and conversion. Specifically, electrical portion 360 of the renewable power generating unit 100 of the block diagram 500 of FIG. 9 may include storing the DC power in the energy storage system 60. Energy storage system 60 may include a battery, an accumulator, etc. Further, any battery arrangement suitable for an Energy Storage Unit (ESS) may be used.

Electrical portion 360 of the renewable power generating arrangement 100 may also include an inverter 70 to convert the generated DC power into alternating current (AC). For example, the inverter 70 may be a sine wave inverter, a square wave inverter, etc. The ESS 60 may be connected to inverter unit 70 to convert DC to any desired AC voltage, as well as single phase or 3-phase current can be delivered for ultimate use.

The renewable power generating arrangement 100 may further include transferring the AC power to a building power arrangement. The AC power may have the voltage, phase, frequency and waveform required by a facility power unit. The AC power may run electrical appliances of the rated voltage within building 300, or may be sold to an electrical power grid.

Turning now to FIG. 10, FIG. 10 is a block diagram 600 illustrating an alternative embodiment of the present invention. In the embodiment of FIG. 10, a modified version of the renewable power generating arrangement 100 of FIG. 1 is installed on roof 340 of building 300. Unlike the block diagram 500 of FIG. 9, the block diagram 600 of FIG. 10 omits exhaust air heater 40 from the enthalpy boosting unit 350. Accordingly, the renewable power generating unit illustrated in FIG. 10 may include a wind capture unit 10 to collect incident ambient wind. As shown in FIG. 3, the wind capture unit 10 may include openings (faces) 14 in all four directions so that no adjustment needs to be made to compensate for shifts in wind direction. The influx air 200 may be guided into duct 20. The duct 20 may have a tapered cross-sectional area 22 to increase the velocity of influx air 20 prior to impinging on generator unit 50. For example, the velocity of the influx air 200 of 10 mph may be increased to 300 mph through a reduction in cross-sectional area by a factor of 30.

Unlike the arrangements 100 of FIGS. 1 and 9, the block diagram 600 of FIG. 10 differs in that enthalpy boosting unit 350 omits exhaust air heater 40 so that enthalpy boosting unit consists of just solar heater 30. As with the arrangement 100 of FIG. 1, the arrangement 600 of the embodiment of FIG. 10 may heat the influx air 200 using solar heater 30. The solar heater 30 may facilitate heating of the influx air 200 in duct 20 thereby boosting the energy content U of influx air flow 200. The solar heater 30 may include a solar collector 32. For example, the solar collector 32 may be a flat plate solar collector, an evacuated tube collector, a parabolic collector, etc. The solar collector 32 may collect solar energy from the sun. The solar energy collected by solar collector 32 may be transferred to heat transfer fluid 34. The heat transfer fluid 34 may be associated with heat energy and may include at least one of water, glycol, refrigerant, etc. The heat transfer fluid 34 circulates to transport heat from collector 32 to heat exchanger 38 so that the heat can be added to influx air flow 200 within duct 20.

The arrangement 600 of FIG. 10 may further include a generating unit 50 to produce DC power from the influx air 200. Generating unit 50 may include a DC generator 52 which may be a turbine-generator unit and a turbofan 54, which could be an axial flow turbofan. The influx air 200 may be fed into the turbofan-generator unit 50 so that turbofan 54 is immersed in influx air flow 200, enabling turbofan 54 to rotate. This rotation of turbofan 54 allows DC generator 52 to produce DC electricity. The DC generator 52 may generate DC power, and may be a permanent magnet DC generator, a separately excited DC generator, a self-excited DC generator, etc.

The arrangement 600 of FIG. 10 may include an electrical portion 360 that may include an energy storage system (ESS) 60 to store the produced DC power. For example, the ESS 60 may be a battery, an accumulator, etc. Further, any battery unit suitable for an Energy Storage Unit (ESS) 60 may be used. Electrical portion 360 may further include an inverter 70 to convert the DC power into an AC power. For example, the inverter 70 may be a sine wave inverter, a square wave inverter, etc. Electrical portion 360 may produce the AC electricity with a proper voltage, phase, waveform and frequency that is compatible with appliances within building 300 or with an electrical grid. Electrical portion 360 may also include a meter to measure an amount of power produced.

The arrangement 600 of FIG. 10 emphasizes that the addition of other mass flows 42 and/or 44 need not be present in all applications to be within the scope of the present invention, as they may be part of the system only if economically justified.

Accordingly, the inventive renewable power generating arrangements of the present invention allows for a more efficient production of renewable electrical energy and power on a rooftop of a building, and does so with a more compact and aesthetically pleasing construction. By being able to receive or collect wind from all compass points without the need for adjustment, simplicity and efficiency are improved. Also, the present renewable power generation arrangements use solar energy and exhaust air from building exhaust to boost an energy content of the influx air flow 200, thereby boosting electricity production.

Though the inventive concept has been described with reference to exemplary embodiments illustrated in the drawings, these are provided for an exemplary purpose only, and one of ordinary skill in the art will understand that various modifications and other equivalent embodiments may be made therein. Therefore, the spirit and scope of the inventive concept should be defined by the following claims.

What is claimed is:

1. A renewable power production arrangement, the arrangement comprising:
a duct to allow an influx air flow to travel therein;
a wind capture unit connected to the duct and including a plurality of faces to receive ambient wind from an atmosphere and produce the influx air flow; and
a generator to convert the influx air flow into electricity, the wind capture unit being adapted to receive wind from all points of compass to avoid adjustment upon shifts in incident wind direction.

2. The arrangement of claim 1, wherein the plurality of faces comprises at least four faces corresponding to North, South, East and West compass directions to receive said ambient wind from any and all compass directions without a need to adjust the wind capture unit.

3. The arrangement of claim 1, wherein the duct comprises a tapered portion to increase a speed of the influx air flow within by reducing a cross-sectional area thereof

4. The arrangement of claim 3, wherein a cross-sectional area of the duct on a side of the tapered portion nearest the generator has a lower area of a cross section of the duct diffuser side.

5. The arrangement of claim 1, further comprising an enthalpy boosting unit to heat the influx air flow within the duct.

6. The arrangement of claim 5, wherein the enthalpy boosting unit comprises a solar heat exchange unit to absorb solar energy and transfer said absorbed solar energy in a form of heat to the influx air flow.

7. The arrangement of claim 6, wherein the enthalpy boosting unit further comprises an exhaust air introduction unit to introduce heated exhaust air from the building into the influx air flow.

8. The arrangement of claim 7, wherein the heated exhaust air is from one or both of ventilation exhaust air and air conditioning exhaust air.

9. The arrangement of claim 6, wherein the solar heat exchange unit comprises:
a solar collector to absorb sunlight radiation and produce heat energy from the absorbed sunlight;
a heat transfer fluid to receive the heat energy from the solar collector;
a heat exchanger to transfer the heat energy from the heat transfer fluid to the influx air flow within the duct.

10. The arrangement of claim 9, further comprising a pump to circulate the heat transfer fluid between the solar collector and the heat exchanger, the solar collector being exposed to direct sunlight.

11. The arrangement of claim 1, the generator being a direct current (DC) generator that comprises:
a turbine section to receive the influx air flow from the duct and convert the influx air flow into rotational energy; and
a generating portion to convert the rotational energy received from the turbofan into DC electricity.

12. The arrangement of claim 11, further comprising an energy storage unit connected to the DC generator to receive and store the DC electricity produced by the DC generator, the energy storage unit being a battery.

13. The arrangement of claim 11, further comprising an inverter connected to the energy storage unit to convert the DC electricity received from the energy storage unit into alternating current (AC) electricity.

14. The arrangement of claim 13, wherein the AC electricity is used to power appliances within the building.

15. The arrangement of claim 7, the generator being a DC generator and comprising:
a turbofan to receive the heated influx air flow from the duct and convert the heated influx air flow into rotational energy; and
a generating portion to convert the rotational energy received from the turbofan into DC electricity, the DC electricity being converted into AC electricity by an inverter prior to powering appliances within the building.

16. A renewable power production arrangement arranged on a rooftop of a building, adjacent to a building, or in a remote location to a building, the renewable power production arrangement comprising:
a wind capture unit to receive and collect ambient wind from an atmosphere;
a duct having a first end opposite a second end, the first end being connected to the wind capture unit to receive the collected ambient wind from the wind capture unit and to produce an influx air flow within the duct;
a generator connected to the second end of the duct to convert the influx air flow into electricity; and
an enthalpy boosting unit to introduce energy into the influx air flow within the duct at a location between the first and second ends, the introduced energy being received from a source selected from a solar collector, ventilation exhaust from the building and air conditioning exhaust from the building.

17. The arrangement of claim 16, wherein the wind capture unit is adapted to receive wind from all compass directions without having to be adjusted for shifts in incident wind direction by including a plurality of faces that face in differing compass directions.

18. The arrangement of claim 16, wherein the wind capture unit is adapted to automatically receive wind from all directions without adjustment, wherein the duct further comprises a tapered portion between the first and second ends to increase a speed of the influx air flow by reducing a cross-sectional area of the duct prior to introduction of the influx air flow into the generator.

19. The arrangement of claim 16, the duct further comprising insulation on an outer surface thereof to prevent an escape of heat, the generator including a turbofan adapted to be immersed in an influx air flow having a speed in a range of 100 to 1000 mph.
